(19) United States
(12) Patent Application Publication
(10) Pub. No.: US 2012/0177510 A1
(43) Pub. Date: Jul. 12, 2012

(54) HIGH-SPEED CHECK VALVE SUITABLE FOR CRYOGENS AND HIGH REVERSE PRESSURE

(75) Inventors: Daniel L. DELONG, Mojave, CA (US); Michael E. VALANT, Tehachapi, CA (US); Jeffrey K. GREASON, Tehachapi, CA (US)

(73) Assignee: XCOR Aerospace, Inc., Mojave, CA (US)

(21) Appl. No.: 13/345,614

(22) Filed: Jan. 6, 2012

Related U.S. Application Data
(60) Provisional application No. 61/430,929, filed on Jan. 7, 2011.

(51) Int. Cl. F04B 49/00; F16K 15/00

(52) U.S. Cl. 417/297; 137/527

(57) ABSTRACT

A check valve is disclosed that includes a base having a porous first surface, a keeper coupled to the base, and a flexible leaf with a first section that is fixedly coupled between the keeper and the base and a second section that is cantilevered from the first section. The leaf has a first position when the leaf is fully in contact with the base and a second position when the leaf is fully in contact with the keeper. The leaf is configured to sealingly cover the porous first surface when the leaf is in the first position. The leaf is in an unstressed configuration when in the first position, and a maximum stress in the leaf is less than the yield stress when the leaf is in the second position. The check valve is particularly suited for use with cryogenic fluids such as liquid hydrogen and liquid oxygen.

### CROSS-REFERENCE TO RELATED APPLICATIONS

The present application claims priority to U.S. Provisional Application No. 61/430,929, filed Jan. 7, 2011, which is incorporated herein by reference.

### STATEMENT REGARDING FEDERALLY SPONSORED RESEARCH OR DEVELOPMENT

Not applicable.

### BACKGROUND

1. Field

The present invention generally relates to a check valve and more particularly to a check valve for use with a reciprocating pump.

2. Description of the Related Art

Reed-valves, such as a leather flap covering a hole, are amongst the earliest form of automatic flow control for liquids and gases. They have been used for thousands of years in water pumps and for hundreds of years in bellows for high-temperature forges and musical instruments such as church organs and accordions.

Reed valves are commonly used in high-performance versions of the two-stroke engine, where they control the fuel-air mixture admitted to the cylinder. High-speed impact takes its toll on all reed valves, with metal valves suffering in fatigue, leading to breakage. Another problem experienced by metal reed valves is that the leaf becomes permanently deformed after a certain amount of time in service. This deformation leads to “leakage,” i.e. the leaf no longer fully seals against the base plate. As a result, composite materials, such as fiberglass or carbon fiber reinforced epoxy composite (FRC) laminates, are preferred in racing engines, especially in kart racing, because the stiffness of the petals can be easily tuned and they are relatively safe in failure. A typical FRC leaf is 0.020 inch or more in thickness.

### SUMMARY

It is desirable to provide a check valve that can operate at temperatures down to −452° F. at cycle rates of greater than 15 cycles per second. The check valve uses a cantilevered leaf that is restrained by a shaped keeper that limits the motion of the leaf so as to maintain the maximum stress in the leaf below a target value, such as the yield stress. A pair of such check valves can be combined with a reciprocating cylinder to provide a compact positive-displacement pump that is suitable for use in a rocket propulsion system utilizing liquid fuels and/or oxidizers, such as liquid oxygen as an oxidizer and liquid hydrogen or liquid methane as a fuel.

In certain embodiments, a check valve is disclosed that includes a base having a first surface, wherein the base is porous over at least a portion of the first surface, a keeper coupled to the base, and at least one leaf comprising a material having a yield stress. The at least one leaf has a first section that is fixedly coupled between the keeper and the base and a second section that is cantilevered from the first section. The at least one leaf has a first position when the leaf is fully in contact with the base and a second position when the leaf is fully in contact with the keeper. The at least one leaf is configured to sealingly cover the at least one porous portion of the first surface when the at least one leaf is in the first position. The at least one leaf is in an unstressed configuration when in the first position, and a maximum stress in the at least one leaf when the at least one leaf is in the second position is less than the yield stress.

In certain embodiments, a dual check valve is disclosed that includes a base comprising a first surface and a second surface, wherein the base is porous over at least a portion of the first surface and a portion of the second surface. The valve also includes a first keeper coupled to the base proximate to the first surface and a second keeper coupled to the base proximate to the second surface. The valve has a first leaf comprising a first material having a first yield stress with a first section that is fixedly coupled between the first keeper and the base and a second section that is cantilevered from the first section and a second leaf comprising a second material having a second yield stress, the second leaf also having a first section that is fixedly coupled between the second keeper and the base and a second section that is cantilevered from the first section. The first and second leaves each have a first position when the leaf is fully in contact with the respective surface of the base, the leaves configured to sealingly cover the porous portion of the respective surface while in an unstressed condition when in the first position. The first and second leaves each also have a second position when the leaf is fully in contact with the respective keeper, a maximum stress in each of the first and second leaves being less than the respective first and second yield stress when the respective leaf is in the second position.

In certain embodiments, a pump adapted to transfer liquid from a source to a destination is disclosed. The pump includes a reciprocating cylinder, a first check valve coupled between the source and the cylinder, and a second check valve coupled between the cylinder and the destination. Each of the check valves has a base comprising a first surface, wherein the base is porous over at least a portion of the first surface, a keeper coupled to the base, and at least one leaf comprising a material having a yield stress. The at least one leaf has a first section that is fixedly coupled between the keeper and the base and a second section that is cantilevered from the first section. The at least one leaf has a first position when the leaf is fully in contact with the base and a second position when the leaf is fully in contact with the keeper. The at least one leaf is configured to sealingly cover the at least one porous portion of the first surface when the at least one leaf is in the first position. The at least one leaf is in an unstressed configuration when in the first position and a maximum stress in the at least one leaf when the at least one leaf is in the second position is less than the yield stress.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 depicts a self-propelled satellite being deployed from a manned space vehicle according to certain aspects of the present disclosure.

FIG. 2 is a schematic of a propulsion system according to certain aspects of the present disclosure.

FIG. 3 is a schematic of a reciprocating pump according to certain aspects of the present disclosure.

FIGS. 4A-4C depict an exemplary embodiment of a high-speed check valve according to certain aspects of the present disclosure.

FIGS. 5A-5B are cross-sectional views of the check valve of FIGS. 4A and 4C, respectively, according to certain aspects of the present disclosure.

FIGS. 6A-6C depict various views of another embodiment of a high-speed check valve according to certain aspects of the present disclosure.

FIGS. 7A and 7B are perspective and cross-sectional views, respectively, of another embodiment of a high-speed check valve according to certain aspects of the present disclosure.

FIGS. 8A-8C are various views of another embodiment of a high-speed check valve according to certain aspects of the present disclosure.

### DETAILED DESCRIPTION

The following description discloses embodiments of a check valve suitable for preventing a backflow of a fluid under severe operating conditions including high-frequency oscillations in the fluid pressure. This type of check valve is particularly suited for use with a reciprocating pump operating at rates of 15 cycles per second (cps) or greater as well as with cryogenic fluids such as liquid oxygen, liquid hydrogen, and liquid methane. In certain embodiments, this type of check valve is suitable for use as part of a spacecraft propulsion system.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

As used within this disclosure, the term “unstressed” means a state in which the stresses within an object are low compared to the stresses induced by applied forces during operation of the object. There may be stresses in the material of the object induced by non-time-varying aspects of the installation. For example, a flexible, flat object held against a rigid, flat surface may be slightly displaced from its lowest-stress configuration by small variations in one or both of the object and surface, yet the condition of the flexible flat object lying against the rigid flat surface is still considered the unstressed state of this configuration of object and surface. As a second example, a portion of the object may be clamped by a mechanism that restrains the object and induces compressive forces in that portion. As a further example, prior processing of the object, such as cold working, may have created residual stresses within the object that are present even in the absence of any external force.

As used within this disclosure, the term “yield” means a tensile or compressive stress level that, if reached at any time during operation, creates a permanent change in the unstressed configuration of an object.

As used within this disclosure, the term “porous” means that a fluid will pass through a porous portion of object. Such a porous region may be selectively porous within that region, i.e. part of the porous region does not allow fluid through while the remaining portion of the porous region does allow fluid through. A flat sheet of metal having numerous holes through the sheet is considered to be porous as a whole even though locally the fluid can only pass through the holes. Characterization of a region as porous treats the entire defined region as having a common ability to allow fluid to pass through regardless of the local characteristics within the porous region.

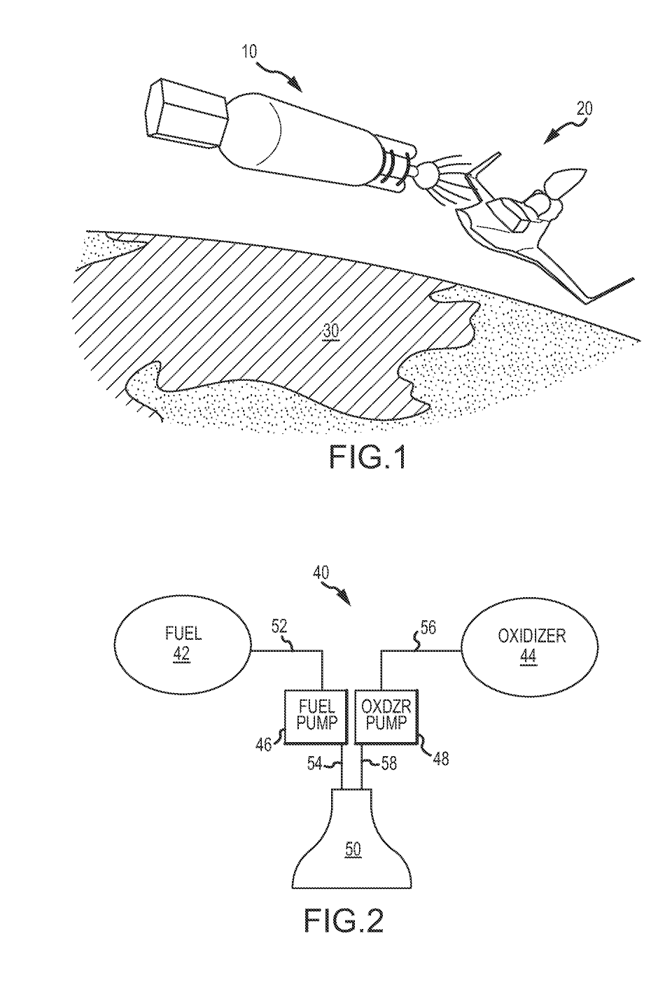

FIG. 1 depicts a self-propelled space vehicle 10 being deployed from a manned space vehicle 20 according to certain aspects of the present disclosure. In certain embodiments, the manned space vehicle 20 is launched from the Earth 30 carrying the self-propelled space vehicle 10 and then releases the self-propelled space vehicle 10. The propulsion system (not visible) of the self-propelled space vehicle 10 is then activated and the self-propelled space vehicle 10 is accelerated to a new orbit.

FIG. 2 is a schematic of a propulsion system 40 according to certain aspects of the present disclosure. In this example, a fuel 42, such as kerosene, and an oxidizer 44, such as liquid oxygen, are drawn from the respective tanks through line 52 by fuel pump 46 and through line 56 by oxidizer pump 48 and forced through lines 54 and 58 to a nozzle 50 where the fuel 42 and oxidizer 44 are combined and ignited. In certain embodiments, the tanks containing the fuel 42 and oxidizer 44 are pressurized, for example with helium, to reduce cavitation when the pumps 46, 48 are drawing liquid from the tanks. It is advantageous to maintain the flow rates of the fuel 42 and oxidizer 44 as constant as possible and at a ratio that also remains as constant as possible. A positive-displacement pumping element, such as a reciprocating cylinder, is advantageous, compared to a turbine or centrifugal pump, in that the flow rate is positively determined independent of pressure within the lines 52, 54, 56, and 58 of system 40.

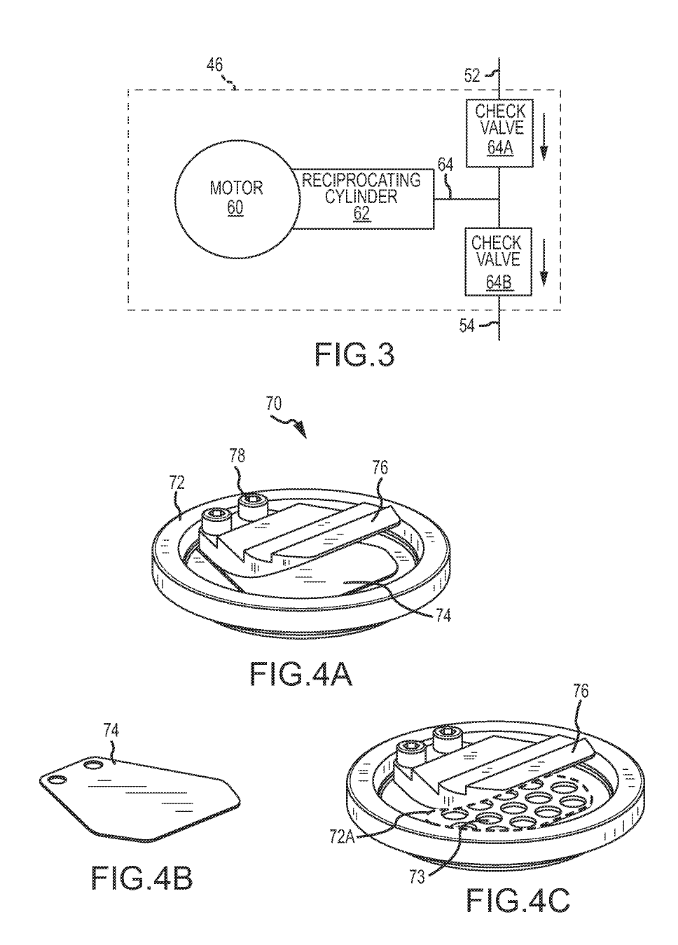

FIG. 3 is a schematic of a reciprocating pump 46 according to certain aspects of the present disclosure. The pump 46 comprises a reciprocating cylinder 62 driven by a motor 60 and, in certain embodiments, a linkage (not shown) that converts the rotary motion of the motor 60 into reciprocating linear motion. In certain embodiments, the motor is a reciprocating linear actuator that drives the cylinder 62 directly. In this example, the cylinder 62 is connected through a single line 64 to an upstream check valve 64A and a downstream check valve 64B. The flow directions of the valves 64A, 64B are indicated by the adjacent arrows.

In operation, as the reciprocating cylinder 62 is retracted, i.e. the internal volume is expanding, fluid will be drawn from line 52 through valve 64A and into the cylinder 62 while valve 64B prevents fluid from line 54 from flowing toward the cylinder 62. When the cylinder 62 is extended, i.e. the internal volume is being reduced, fluid is forced from the cylinder 62 through line 64 and valve 64B into line 54 while valve 64A prevents any fluid from entering line 52. Thus for each cycle of retraction and extension of the reciprocating cylinder, a volume of fluid that is equal to the displacement of the cylinder 62 is drawn from line 52 and expelled into line 54. If the speeds of retraction and extension of the reciprocating cylinder 62 are constant, then the instantaneous flow rate through lines 52 and 54 are approximately square waves that are 180° out of phase with each other. If the speeds of retraction and extension of the reciprocating cylinder 62 vary over the stroke of the cylinder 62, for example due to the design of the linkage, then the flow rates will vary with time but will still have a 50% duty cycle, i.e. no fluid flows 50% of the time.

As the combustion process in nozzle 50 benefits from a constant flow rate, the intermittent flow characteristics of reciprocating pump 62 are undesirable. One approach to reducing the effect of the intermittent flow for a given desired flow rate is to reduce the reciprocating volume of the cylinder 62 and increase the speed of reciprocation. For example, two pumps will have the same average flow rate if the first pump has a reciprocating volume that is one-tenth that of a second pump but runs at ten times the speed of the second pump. The smaller pump is also advantageous in applications such as spacecraft where reducing the weight and volume of equipment is very important. In certain applications, such as the self-propelled spacecraft of FIG. 1, a reciprocating pump may operate at a speed of 15 cps or more to achieve a flow rate of 1-2 kilograms per second (kps) or higher at a pressure of 250 pounds per square inch (psi) or higher. In larger vehicles, the flow rates or pressures may be higher. In certain applications, two or more pumps may be arranged in parallel and 180° or less out of phase so that the combined output of the two or more pumps is more constant. In certain embodiments, a single motor may drive two or more reciprocating cylinders 180° out of phase with other.

FIGS. 4A-4C depict an exemplary embodiment of a high-speed check valve 70 according to certain aspects of the present disclosure. FIG. 4A shows an assembled check valve 70 comprising a base 72, a metal flap or “leaf” 74, and a keeper 76 that is attached to the base 72 with a pair of screws 78 that pass through the leaf 74 and capture the leaf 74 in a cantilever configuration.

The base 72 has a porous region 72A (visible in FIG. 4C). In this example, the unstressed position of the leaf 74 covers the porous region 72A. In certain embodiments, the entire porous region is a single opening through the base 72. In certain embodiments, the porous region 72A comprises a plurality of holes 73 separated by bridging material that provides support to the leaf 74 when the leaf 74 is forced against the base 72 by a pressure gradient across the valve 70.

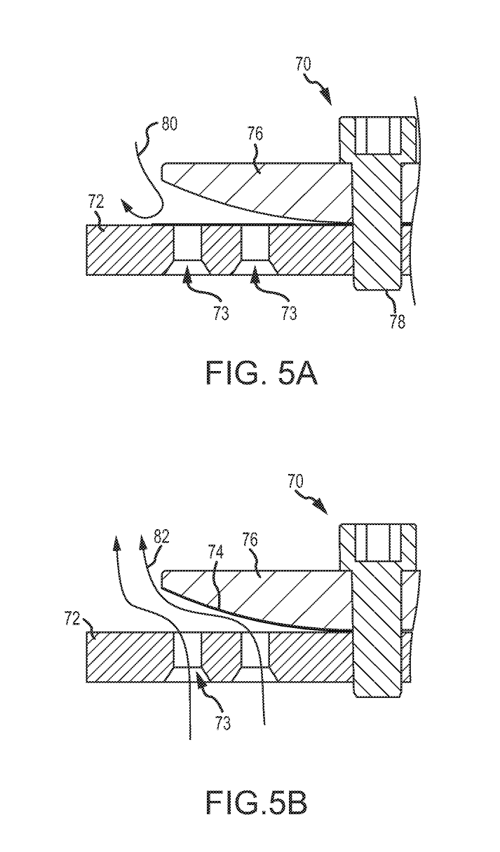

The keeper 76 has a curved underside that, in certain embodiments, limits the deformation of the leaf 74 such that the stresses in the leaf 74 remain below yield. In certain embodiments, the curve is selected such that the stress within the leaf 74 is constant along the leaf 74. In certain embodiments, the shape of keeper 76 is selected to provide a determined fatigue life for leaf 74. In certain embodiments, the shape of the keeper 76 is selected such that the leaf 74 continuously bends locally at the point of tangency as the leaf 74 further wraps around the keeper 76, thereby eliminating a shock load to the leaf 74. An example of this continuous curve in the contact surface for the leaf 74 can be seen in the cross-section of keeper 76 in FIG. 5B.

The leaf 74, keeper 76, and base 72 are designed as a system to provide capabilities not available with conventional check valves such as the reed valves of two-stroke motorcycle engines. A check valve 70 must withstand the line pressure of the pump that may exceed 250 psi, compared to the one atmosphere (14.7 psi) pressure differential of a two-stroke engine. Two-stroke engines are also notorious for breaking the reeds of the intake systems as the reeds are allowed to flex far beyond their fatigue limits in order to increase the flow volume. The leaves 74 have a low mass so as to transition between their fully open and fully closed positions as quickly as possible at cycle rates of 15 cps or more.

The leaf 74 of FIG. 4B is, in certain embodiments, formed from 6061 or 7075 aluminum or 302 or 304 stainless steel to withstand the temperatures of cryogenic operation, or from Inconel 625 to withstand exposure to liquid oxidizers and other corrosive liquids. In certain embodiments, the leaves 74 are fully hardened as well as roll hardened to develop compressive stresses in the surface layers to increase their fatigue life. In certain embodiments, leaves 74 have a thickness in the range of 0.005-0.015 inches. In certain preferred embodiments, leaves 74 have a thickness in the range of 0.006-0.009 inches. In certain preferred embodiments, leaves 74 have a thickness of 0.007 inches.

FIG. 4C depicts valve 70 in the “open” position, wherein leaf 74 is fully deformed and pressing against the underside of keeper 76. The holes 73 that are part of the porous region 72A of base 72 are visible in FIG. 4C. When the keeper 76 is designed to maintain the stresses in the leaf 74 below the fatigue threshold, the check valve 70 has effectively infinite life. If it is desirable to provide more deflection of the leaf 74 so as to increase the flow rate through the valve 70, the shape of the keeper 76 can be modified to allow a higher stress level in leaf 74 at the cost of fatigue life. In certain applications, for example an expendable booster rocket, the required life of the check valve 70 may be known and therefore the design can be tailored to provide this life with a defined margin while maximizing the flow of the valve 70.

FIGS. 5A-5B are cross-sectional views of the check valve 70 in the positions of FIGS. 4A and 4C, respectively, according to certain aspects of the present disclosure. FIG. 5A shows valve 70 in the “closed” or “blocked” position, wherein leaf 74 is covering the openings 73 of base 72 and blocking the flow 80 of the fluid, as indicated by the flow curling back on itself.

FIG. 5B shows valve 70 in the “open” position. There is a pressure differential across the base 72, with the pressure in the fluid below the base 72 higher than the pressure in the fluid above the base 72, such that the leaf 74 is forced upward until it is restrained by keeper 76. As the holes 73 are now unobstructed, the fluid flows as indicated by arrows 82 through the base 72.

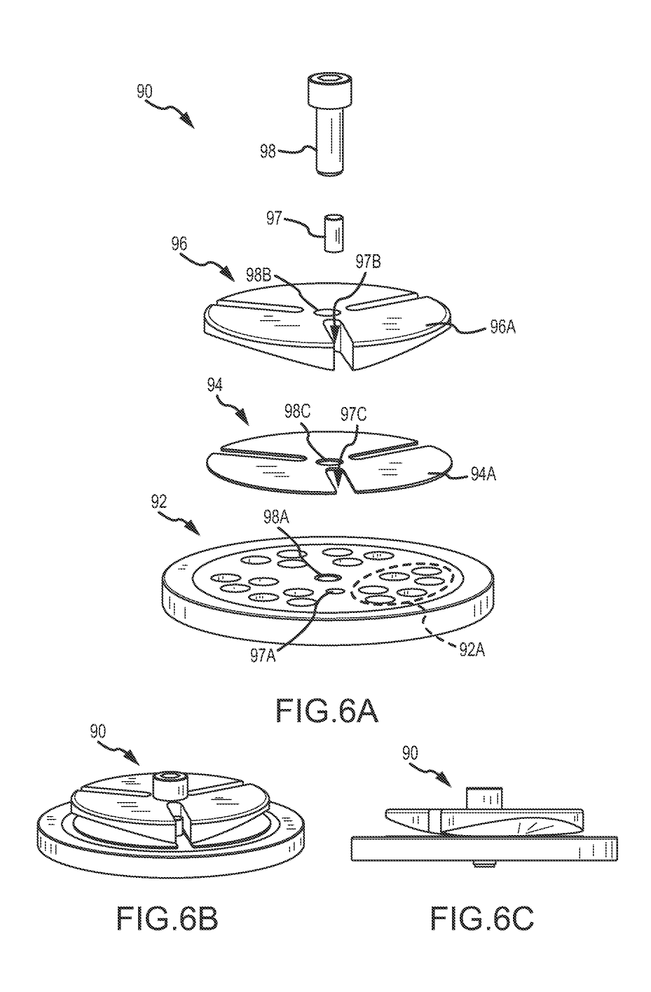

FIGS. 6A-6C depict various views of another embodiment of a high-speed check valve 90 according to certain aspects of the present disclosure. FIG. 6A is an exploded view of the valve 90, showing the base 92, multi-leaf flap 94, multi-element keeper 96, alignment pin 97, and attachment screw 98 (threads not shown). It can be seen that there are three independent regions, wherein the porous region 92A of base 92 corresponds to the leaf 94A and the keeper element 96A. The alignment pin fits through the slots 97B and 97C and into hole 97A to maintain the alignment of the various components. The attachment screw 98 fits through the central holes 98B and 98C and into hole 98A.

FIG. 6B is a perspective view of the assembled valve 90 and FIG. 6C is a side view of the assembled valve 90.

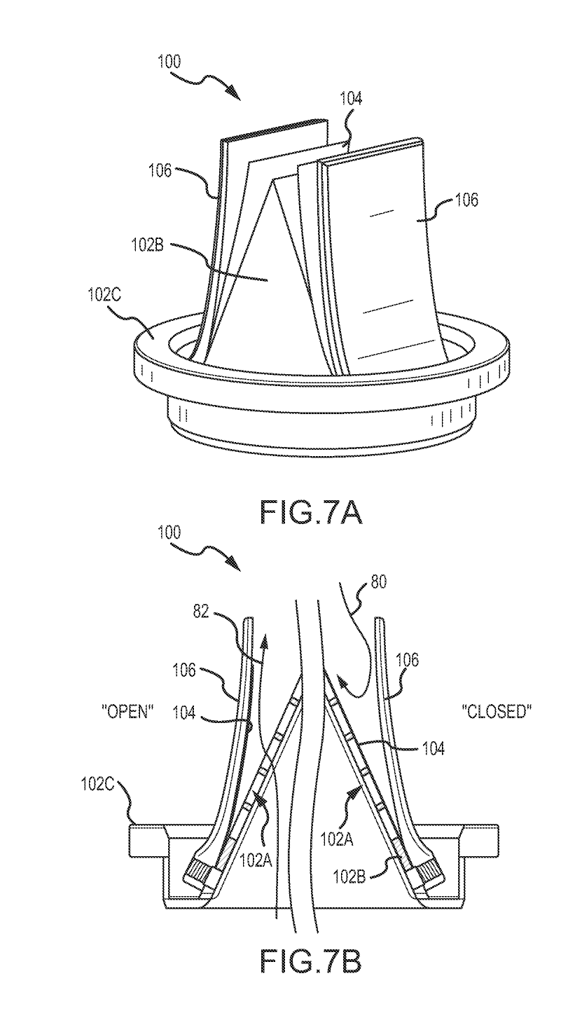

FIGS. 7A and 7B are perspective and cross-sectional views, respectively, of another embodiment of a high-speed check valve 100 according to certain aspects of the present disclosure. This embodiment has a pair of leaves 104 arranged on opposite sides of a base having a central triangular portion 102B with holes 102A (visible in FIG. 7B) and an outer ring portion 102C. A pair of keepers 106 are arranged on each side of the triangular portion 102B.

FIG. 7B is a split view of a cross-section of the check valve 100 of FIG. 7A, wherein the left half of the view is the valve 100 in the “open” position wherein in can be seen that fluid flow 82 passes upward, in this orientation, through the valve 100. The right half of FIG. 7B depicts the valve 100 in the “closed” position, wherein the flow 80 is blocked as indicated by the reversal of the flow arrow.

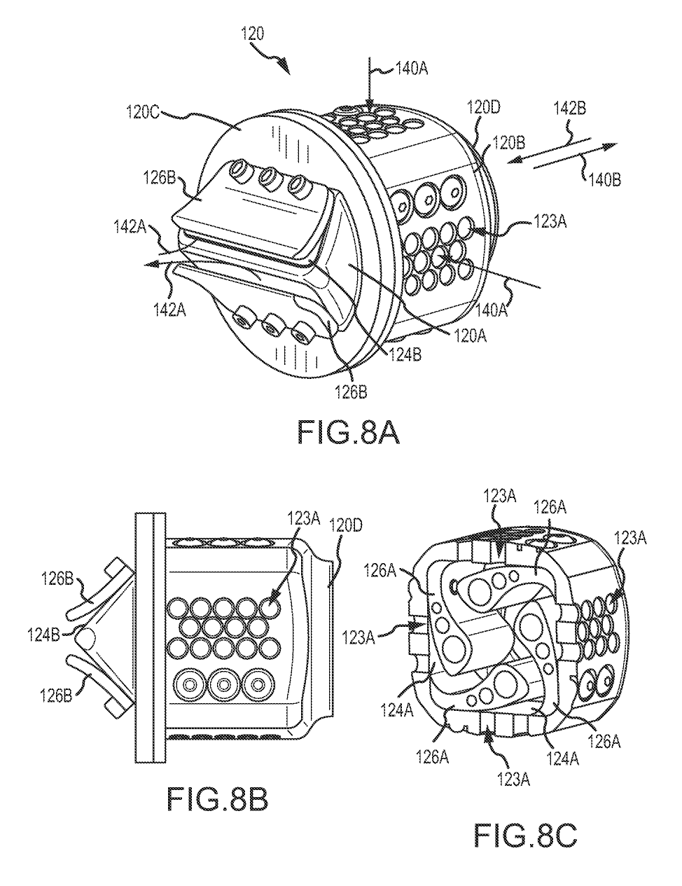

FIGS. 8A-8C are various views of another embodiment of a high-speed check valve 120 according to certain aspects of the present disclosure. FIG. 8A is a perspective view of the complete assembled valve 120, FIG. 8B is an external side view, and FIG. 8C is a perspective cut-away view of the rear portion of the assembled valve 120. The right end 120D is coupled to the line 64 of FIG. 3, wherein the two flow lines 140B and 142B indicate the reversing flow through line 64 as the reciprocating cylinder 62 retracts and extends. Each of the four sides of body portion 120B has a plurality of holes 123A that are all coupled to line 52 of FIG. 3. The two sides of the triangular body portion 120A have holes (not visible) that are coupled to line 54 on FIG. 3.

When the reciprocating cylinder 62 retracts, thereby creating flow 140B in line 64, the four leaves 124A (visible in FIG. 8C) are deflected against the four keepers 126A (visible in FIG. 8C) and fluid flows from line 52 as shown by flow arrows 140A into the interior of body 120B through the holes 123A while the two leaves 124B are pulled against the surface of body portion 120A, thereby preventing flow from line 54.

When the reciprocating cylinder 62 extends, thereby creating flow 142B, the four leaves 124A (visible in FIG. 8C) are pulled against the surfaces of the four keepers 126A, thereby preventing flow into line 52, while the two leaves 124B are pushed against the keepers 126B and fluid flows as indicated by flow arrows 142A into line 54.

The disclosed examples of flow control check valves depict systems for providing single-direction flow under higher pressures and with more reactive fluids that available with conventional reed valves. It will be apparent to those of skill in the art that valves can be constructed with a variable number of sets of base-leaf-keeper as well as integrated into a single valve assembly, such as valve 120, that provides complete flow control and replaces the two check valves 64A and 64B of FIG. 3.

It is understood that the specific order or hierarchy of steps or blocks in the processes disclosed is an illustration of exemplary approaches. Based upon design preferences, it is understood that the specific order or hierarchy of steps or blocks in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims.

Reference to an element in the singular is not intended to mean “one and only one” unless specifically so stated, but rather “one or more.” Use of the articles “a” and “an” is to be interpreted as equivalent to the phrase “at least one.” Unless specifically stated otherwise, the term “some” refers to one or more.

Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “operation for.”

Although embodiments of the present disclosure have been described and illustrated in detail, it is to be clearly understood that the same is by way of illustration and example only and is not to be taken by way of limitation, the scope of the present invention being limited only by the terms of the appended claims.

What is claimed is:

1. A check valve comprising:
a base comprising a first surface, wherein the base is porous over at least a portion of the first surface;
a keeper coupled to the base; and
at least one leaf comprising a material having a yield stress, the at least one leaf further comprising a first section that is fixedly coupled between the keeper and the base and a second section that is cantilevered from the first section, the at least one leaf having a first position when the leaf is fully in contact with the base and a second position when the leaf is fully in contact with the keeper, the at least one leaf configured to sealingly cover the at least one porous portion of the first surface when the at least one leaf is in the first position,
wherein the at least one leaf is in an unstressed configuration when in the first position and wherein, when in the second position, the at least one leaf has a maximum stress that is less than the yield stress.

2. The check valve of claim 1, wherein the leaf comprises a metal.

3. The check valve of claim 2, wherein the leaf is 0.005-0.020 inch in thickness.

4. The check valve of claim 3, wherein the leaf is approximately 0.007 inch in thickness.

5. The check valve of claim 2, wherein the leaf comprises a fully hardened metal that has been roll hardened with a compressive residual stress layer at the surface.

6. The check valve of claim 5, wherein the metal is selected from the group consisting of 302 and 304 stainless steel, 6061 and 7075 aluminum, Inconel 625, and alloys having a composition of at least 70% by weight of the total of nickel and chromium.

7. The check valve of claim 1, wherein the leaf and base are configured to withstand a reverse-flow pressure differential greater than or equal to 15 psi.

8. The check valve of claim 7, wherein the leaf and base are configured to withstand a reverse-flow pressure differential greater than or equal to 250 psi.

9. The check valve of claim 1, wherein the porous portion of the base comprises a plurality of holes through the base.

10. The check valve of claim 9, wherein the porous portion of the base comprises at least five holes.

11. The check valve of claim 1, wherein the valve is configured to operate at a speed of at least 15 cycles per second (cps), wherein a cycle comprises movement of the leaf from the first position to the second position and back to the first position.

12. The check valve of claim 11, wherein the valve is configured to operate at a speed of at least 50 cps.

13. The check valve of claim 12, wherein the valve is configured to flow at least 2 kilograms/second of liquid oxygen.

14. The check valve of claim 12, wherein the valve is configured to flow at least 1 kilogram/second of kerosene.

15. The check valve of claim 1, wherein the valve is configured to operate while in contact with liquids at a temperature below −200° F.

16. The check valve of claim 15, wherein the valve is configured to operate while in contact with liquids at a temperature below −450° F.

17. A dual check valve comprising:
a base comprising a first surface and a second surface, wherein the base is porous over at least a portion of the first surface and a portion of the second surface;
a first keeper coupled to the base proximate to the first surface;
a second keeper coupled to the base proximate to the second surface;
a first leaf comprising a first material having a first yield stress, the first leaf further comprising a first section that is fixedly coupled between the first keeper and the base and a second section that is cantilevered from the first section;
a second leaf comprising a second material having a second yield stress, the second leaf further comprising a first section that is fixedly coupled between the second keeper and the base and a second section that is cantilevered from the first section;
wherein the first and second leaves each have a first position when the leaf is fully in contact with the respective surface of the base, the leaves configured to sealingly cover the porous portion of the respective surface while in an unstressed condition when in the first position, and
wherein the first and second leaves each have a second position when the leaf is fully in contact with the respective keeper, a maximum stress in each of the first and second leaves being less than the respective first and second yield stress when the respective leaf is in the second position.

18. The dual check valve of claim 17, wherein the first and second leaves and the base are configured to withstand a reverse-flow pressure differential greater than or equal to 15 pounds per square inch (psi).

19. The dual check valve of claim 18, wherein the first and second leaves and the base are configured to withstand a reverse-flow pressure differential greater than or equal to 250 psi.

20. The dual check valve of claim 17, wherein the porous portions of the base each comprise a plurality of holes through the base.

21. The dual check valve of claim 20, wherein the porous portions of the base each comprise at least 5 holes.

22. The dual check valve of claim 17, wherein the valve is configured to operate at a speed of at least 15 cycles per second (cps), wherein a cycle comprises movement of the first leaf from the first position to the second position and back to the first position while the second leaf simultaneously moves from the second position to the first position and back to the second position.

23. The dual check valve of claim 22, wherein the valve is configured to operate at a speed of at least 50 cps.

24. The dual check valve of claim 23, wherein the valve is configured to flow at least 2 kilograms/second of liquid oxygen.

25. The dual check valve of claim 23, wherein the valve is configured to flow at least 1 kilogram/second of kerosene.

26. The dual check valve of claim 17, wherein the valve is configured to operate while in contact with liquids at a temperature below −200° F.

27. The dual check valve of claim 26, wherein the valve is configured to operate while in contact with liquids at a temperature below −450° F.

28. A pump adapted to transfer liquid from a source to a destination, the pump comprising:
a reciprocating cylinder; and
a first check valve coupled between the source and the cylinder and a second check valve coupled between the cylinder and the destination, each of the check valves comprising:
a base comprising a first surface, wherein the base is porous over at least a portion of the first surface;
a keeper coupled to the base; and
at least one leaf comprising a material having a yield stress, the at least one leaf further comprising a first section that is fixedly coupled between the keeper and the base and a second section that is cantilevered from the first section, the at least one leaf having a first position when the leaf is fully in contact with the base and a second position when the leaf is fully in contact with the keeper, the at least one leaf configured to sealingly cover the at least one porous portion of the first surface when the at least one leaf is in the first position,
wherein the at least one leaf is in an unstressed configuration when in the first position and wherein, when in the second position, the at least one leaf has a maximum stress that is less than the yield stress.

29. The pump of claim 28, wherein the first and second leaves and the base are configured to withstand a reverse-flow pressure differential greater than or equal to 15 pounds per square inch (psi).

30. The pump of claim 29, wherein the first and second leaves and the base are configured to withstand a reverse-flow pressure differential greater than or equal to 250 psi.

31. The pump of claim 28, wherein the valve is configured to operate at a speed of at least 15 cycles per second (cps), wherein a cycle comprises movement of the first leaf from the first position to the second position and back to the first position while the second leaf simultaneously moves from the second position to the first position and back to the second position.

32. The pump of claim 31, wherein the valve is configured to operate at a speed of at least 50 cps.

33. The pump of claim 32, wherein the pump is configured to provide at least 2 kilograms/second of liquid oxygen.

34. The pump of claim 32, wherein the pump is configured to provide at least 1 kilogram/second of kerosene.

35. The pump of claim 28, wherein the pump is configured to operate while in contact with liquids at a temperature below −200° F.

36. The pump of claim 28, wherein the pump is configured to operate while in contact with liquids at a temperature below −450° F.
